(19) United States
(12) Patent Application Publication
(10) Pub. No.: US 2015/0199784 A1
(43) Pub. Date: Jul. 16, 2015

(54) Systems and Methods For Estimating Probability Of Identity-Based Fraud

(71) Applicant: LexisNexis Risk Solutions FL Inc., Boca Raton, FL (US)

(72) Inventors: Scott M. Straub, Washington, DC (US); Andrew John Bucholz, Alexandria, VA (US); Marlene Thorogood, Boca Raton, FL (US); Lea Smith, Savage, MN (US); Jennifer Paganacci, Delray Beach, FL (US); Monty Faidley, Kennesaw, GA (US); Steve Lappenbusch, Beaverton, OR (US)

(73) Assignee: LEXISNEXIS RISK SOLUTIONS FL INC.

(21) Appl. No.: 14/667,977

(22) Filed: Mar. 25, 2015

Related U.S. Application Data
(63) Continuation-in-part of application No. 14/170,892, filed on Feb. 3, 2014.
Application No. 14/170,892 is a continuation of application No. 13/541,157, filed on Jul. 3, 2012, now Pat. No. 8,682,755.
(60) Provisional application No. 61/970,603, filed on Mar. 26, 2014.

(51) Int. Cl. G06Q 50/26; G06Q 20/40

(52) U.S. Cl. CPC G06Q 50/265; G06Q 20/40

(57) ABSTRACT

Certain embodiments of the disclosed technology may include systems and methods for detecting fraud. A method is provided that includes: receiving entity-supplied information comprising at least a name, a social security number (SSN), and a street address associated with a request for a payment or a benefit; querying one or more databases with the entity-supplied information; receiving a plurality of information in response to the querying; determining a validity indication of the entity supplied information; disambiguating the entity-supplied information responsive to the determined validity indication; scoring, based at least in part on a comparison of the disambiguated entity-supplied information with at least a portion of the plurality of independent information, one or more parameters; determining one or more indicators of fraud based on the scoring; and outputting, for display, one or more indicators of fraud.

### CROSS REFERENCE TO RELATED APPLICATIONS

This application claims priority under 35 U.S.C. §119(e) to U.S. Provisional Patent Application No. 61/970,603, filed 26 Mar. 2014, entitled “Systems and Methods for Estimating Probability of Identity-Based Fraud,” the contents of which are hereby incorporated by reference in its entirety. This application is also a Continuation-in-Part under 37 CFR 1.53(b) of U.S. Non-Provisional patent application Ser. No. 14/170,892, filed 3 Feb. 2014, and entitled “Systems and Methods for Detecting Fraud,” published as U.S. Patent Application Publication No. US2014/0149304 on 29 May 2014, the contents of which are hereby incorporated by reference in its entirety. Application Ser. No. 14/170,892, is a Continuation of U.S. patent application Ser. No. 13/541,157, filed 3 Jul. 2012, and entitled “Systems and Methods for Detecting Tax Refund Fraud,” and issued as U.S. Pat. No. 8,682,755 on 25 Mar. 2014, the contents of which are hereby incorporated by reference in its entirety.

### FIELD

The disclosed technology generally relates to detecting fraud, and in particular, to systems and methods for disambiguating input information and determining a likelihood of fraud.

### BACKGROUND

Businesses and governmental agencies face a number of growing problems associated with identity-based fraud. For example, fraudsters can apply for credit, payments, benefits, tax refunds, etc. by misrepresenting their identity, by stealing and using identity information from another individual, or by using an identity of a deceased person. The associated revenue loss to the businesses and/or government agencies can be significant, and the process of verifying the legitimacy of the requester's identity can create costly delays.

Technically well-informed fraud perpetrators with sophisticated deception schemes are likely to continue targeting business and governmental entities, particularly if fraud detection and prevention mechanisms are not in place. Balancing the threats of identity fraud with efficient service for legitimate requests creates a significant challenge.

### BRIEF SUMMARY

Some or all of the above needs may be addressed by certain embodiments of the disclosed technology. Certain embodiments of the disclosed technology may include systems and methods for estimating the probability of identity-based fraud.

According to an exemplary embodiment of the disclosed technology, a method is provided for disambiguating input information and determining a likelihood of fraud. The method includes receiving entity-supplied information comprising at least a name, a social security number (SSN), and a street address associated with a request for a payment or a benefit; querying one or more public or private databases with the entity-supplied information; receiving a plurality of information in response to the querying; determining, with one or more computer processors in communication with a memory, based at least in part on a comparison of the entity-supplied information with at least a portion of the plurality of independent information, a validity indication of the entity supplied information; disambiguating the entity-supplied information responsive to the determined validity indication; scoring, with one or more computer processors in communication with a memory, based at least in part on a comparison of the disambiguated entity-supplied information with at least a portion of the plurality of independent information, at least one parameter of the entity-supplied information; determining one or more indicators of fraud based on the scoring; and outputting, for display, one or more indicators of fraud.

According to an example implementation of the disclosed technology, a system is provided. The system includes at least one memory for storing data and computer-executable instructions; and at least one processor configured to access the at least one memory and further configured to execute the computer-executable instructions for: receiving entity-supplied information comprising at least a name, a social security number (SSN), and a street address associated with a request for a payment or a benefit; querying one or more public or private databases with the entity-supplied information; receiving a plurality of information in response to the querying; determining, with one or more computer processors in communication with a memory, based at least in part on a comparison of the entity-supplied information with at least a portion of the plurality of independent information, a validity indication of the entity supplied information; disambiguating the entity-supplied information responsive to the determined validity indication; scoring, with one or more computer processors in communication with a memory, based at least in part on a comparison of the disambiguated entity-supplied information with at least a portion of the plurality of independent information, one or more parameters comprising: distance between the entity-supplied street address and a street address of one or more entity relatives or entity associates; number of records associating the entity-supplied SSN and the entity-supplied street address; number of unique SSNs associated with the entity-supplied street address; number sources reporting the entity-supplied SSN with the entity-supplied name; and number of other entities associated with the entity-supplied SSN; determining one or more indicators of fraud based on the scoring; and outputting, for display, one or more indicators of fraud.

Exemplary embodiments of the disclosed technology can include one or more computer readable media comprising computer-executable instructions that, when executed by one or more processors, configure the one or more processors to perform a method. The method includes receiving entity-supplied information comprising at least a name, a social security number (SSN), and a street address associated with a request for a payment or a benefit; querying one or more public or private databases with the entity-supplied information; receiving a plurality of information in response to the querying; determining, with one or more computer processors in communication with a memory, based at least in part on a comparison of the entity-supplied information with at least a portion of the plurality of independent information, a validity indication of the entity supplied information; disambiguating the entity-supplied information responsive to the determined validity indication; scoring, with one or more computer processors in communication with a memory, based at least in part on a comparison of the disambiguated entity-supplied information with at least a portion of the plurality of independent information, one or more parameters comprising: distance between the entity-supplied street address and a street address of one or more entity relatives or entity associates; number of records associating the entity-supplied SSN and the entity-supplied street address; number of unique SSNs associated with the entity-supplied street address; number sources reporting the entity-supplied SSN with the entity-supplied name; and number of other entities associated with the entity-supplied SSN; determining one or more indicators of fraud based on the scoring; and outputting, for display, one or more indicators of fraud.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of various illustrative scenarios associated with a request for payment or benefit, according to exemplary embodiments of the disclosed technology.

FIG. 2 is a block diagram of an illustrative fraud detection system 200 according to an exemplary embodiment of the disclosed technology.

FIG. 3 is a block diagram of an illustrative fraud detection system architecture 300 according to an exemplary embodiment of the disclosed technology.

FIG. 4 is a flow diagram of a method 400 according to an exemplary embodiment of the disclosed technology.

FIG. 5 is a flow diagram of a method 500 according to an exemplary embodiment of the disclosed technology.

FIG. 6 is a flow diagram of a process 600 according to an exemplary embodiment of the disclosed technology.

FIG. 7 is a flow diagram of a method 700 according to an exemplary embodiment of the disclosed technology.

### DETAILED DESCRIPTION

Embodiments of the disclosed technology will be described more fully hereinafter with reference to the accompanying drawings, in which embodiments of the disclosed technology are shown. This disclosed technology may, however, be embodied in many different forms and should not be construed as limited to the embodiments set forth herein; rather, these embodiments are provided so that this disclosure will be thorough and complete, and will fully convey the scope of the disclosed technology to those skilled in the art.

In the following description, numerous specific details are set forth. However, it is to be understood that embodiments of the disclosed technology may be practiced without these specific details. In other instances, well-known methods, structures and techniques have not been shown in detail in order not to obscure an understanding of this description. The term “exemplary” herein is used synonymous with the term “example” and is not meant to indicate excellent or best. References to “one embodiment,” “an embodiment,” “exemplary embodiment,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Certain example embodiments of the disclosed technology may utilize a model to build a profile of indicators of fraud that may be based on multiple variables. In certain example implementations of the disclosed technology, the interaction of the indicators and variables may be utilized to produce one or more scores indicating the likelihood or probability of fraud associated with a request for a payment or a benefit.

According to an example implementation, input information, as supplied by an entity requesting payment or a benefit may include a name, a street address, and a social security number. This input information may be utilized as input to find related information in one or more public or private databases in order to assess the risk of identity-related fraud. Example embodiments of the disclosed technology may be utilized to score indicators of fraud.

For example, in one aspect, addresses associated with the entity and their closest relatives or associates may be may be analyzed to determine distances between the addresses. For example, the greater distance may indicate a higher the likelihood of fraud because, for example, a fraudster may conspire with a relative or associate in another city, and may assume that their distance may buffer them from detection.

Certain example embodiments of the disclosed technology may utilize profile information related to an entity's neighborhood. For example, information such as density of housing (single family homes, versus apartments and condos), the presence of businesses, and the median income of the neighborhood may correlate with a likelihood of fraud. For example, entities living in affluent neighborhoods are less likely to be involved with fraud, whereas dense communities with lower incomes and lower presence of businesses may be more likely to be associated with fraud.

Embodiments of the disclosed technology may assesses the validity of the input identity elements, such as the name, street address, social security number (SSN), phone number, date of birth (DOB), etc., to verify whether or not requesting entity input information corresponds to real identity. Certain example implementations may utilize a correlation between the input SSN and the input address, for example, to determine how many times the input SSN has been associated with the input address via various sources. Typically, the lower the number, then the higher the probability of fraud.

Certain example implementations of the disclosed technology may determine the number of unique SSNs associated with the input address. Such information may be helpful in detecting identity-related fraud, and may also be helpful in finding fraud rings because the fraudsters have typically created synthetic identities, but are requesting all payments be sent to one address.

Certain example implementations may determine the number of sources reporting the input SSN with the input name. If such occurrences are rare, then this is an indication of another synthetic identity being created and used.

Certain example implementations may determine the number of SSNs associated with the identities in one or more pubic or private databases. For example, if the SSN has been associated with multiple identities, then it is likely a compromised SSN and the likelihood of fraud increases.

According to an example implementation, the disclosed technology may be utilized to verify the validity of the input address. For example, if the input address has never been seen in public records, then it is probably a fake address and the likelihood of fraud increases

Certain example implementations of the disclosed technology may be utilized to determine if the input data provided by the requesting entity corresponds to a deceased person, a currently incarcerated person, a person having prior incarceration (and time since their incarceration), and/or whether the person has been involved in bankruptcy. For example, someone involved in a bankruptcy may be less likely to be a fraudster.

Certain embodiments of the disclosed technology may enable the detection of possible, probable, and/or actual identity-related fraud, for example, as associated with a request for credit, payment, or a benefit. Certain example implementations provide for disambiguating input information and determining a likelihood of fraud. In certain example implementations, the input information may be received from a requesting entity in relation to a request for credit, payment, or benefit. In certain example implementations, the input information may be received from a requesting entity in relation to a request for a payment or benefit from a governmental agency.

In accordance with an example implementation of the disclosed technology, input information associated with a requesting entity may be processed, weighted, scored, etc., for example, to disambiguate the information. Certain implementations, for example, may utilize one or more input data fields to verify or correct other input data fields. In certain example implementations, disambiguation may involve a process of data cleansing, for example, by eliminating ambiguity and/or name variations. Certain example implementations of disambiguation may be performed by adding metadata records to the data set that unambiguously identify entities and allows for alternate names.

In a exemplary embodiment, a request for a payment or benefit may be received by the system. For example, the request may be for a tax refund. In one example embodiment, the request may include a requesting person's name, street address, and social security number (SSN), where the SSN has a typographical error (intentional or unintentional). In this example, one or more public or private databases may be searched to find reference records matching the input information. But since the input SSN is wrong, a reference record may be returned matching the entity-supplied name and street address, but with a different associated SSN. According to certain example implementations, the entity-supplied input information may be flagged, weighted, scored, and/or corrected based on one or more factors or attributes, including but not limited to: fields in the reference record(s) having field values that identically match, partially match, mismatch, etc, the corresponding entity-supplied field values.

Example embodiments of the disclosed technology may reduce false positives and increase the probability of identifying and stopping fraud based on a customized identity-based fraud score. According to an example implementation of the disclosed technology, a model may be utilized to process identity-related input information against reference information (for example, as obtained from one or more public or private databases) to determine whether the input identity being presented corresponds to a real identity, the correct identity, and/or a possibly fraudulent identity.

Certain example implementations of the disclosed technology may determine or estimate a probability of identity-based fraud based upon a set of parameters. In an example implementation, the parameters may be utilized to examine the input data, such as name, address and social security number, for example, to determine if such data corresponds to a real identity. In an example implementation, the input data may be compared with the reference data, for example, to determine field value matches, mismatches, weighting, etc. In certain example implementations of the disclosed technology, the input data (or associated entity record) may be scored to indicate the probability that it corresponds to a real identity.

In some cases, a model may be utilized to score the input identity elements, for example, to look for imperfections in the input data. For example, if the input data is scored to have a sufficiently high probability that it corresponds to a real identity, even though there may be certain imperfections in the input or reference data, once these imperfections are found, the process may disambiguate the data. For example, in one implementation, the disambiguation may be utilized to determine how many other identities are associated with the input SSN. According to an example implementation, a control for relatives may be utilized to minimize the number of similar records, for example, as may be due to Jr. and Sr. designations.

In an example implementation, the entity-supplied input data may be utilized to derive a date-of-birth for the requesting entity, for example, based on matching reference records. In one example implementation, the derived date-of-birth may be compared with the issue date of the SSN. If the dates of the SSN are before the DOB, then the flag may be appended for this record as indication of fraud.

Another indication of fraud that may be determined, according to an example implementation, includes whether the entity has previously been associated with a different SSN. In an example implementation, a “most accurate” SSN for the entity may be checked to determine whether the entity is a prisoner, and if so the record may be flagged. In an example implementation, the input data may be checked against a deceased database to determine whether the entity has been deceased for more than one or two years, which may be another indicator of fraud.

### Scoring:

In accordance with certain example embodiments of the disclosed technology, a score may be produced to represent how closely input data matches with the reference data. As discussed above, the input data may correspond to the entity supplied information associated with a request for a benefit or payment. The reference data, according to an example implementation, may be one or more records, each record including one or more fields having field values, and derived from one or more public or private databases. In certain example implementations, the reference data may be the best data available, in that it may represent the most accurate data in the databases. For example, the reference data may have been cross verified among various databases, and the various records and/or fields may be scored with a validity score to indicate the degree of validity.

In certain example implementations of the disclosed technology, the scores that represent how closely input data matches with the reference data scores may range from 0 to 100, with 0 being worst and 100 being best. In other example implementations, a score of 255 may indicate a null value for the score, for example, to indicate that it is not a valid score and should not be read as indicating anything about the goodness of the match.

According to an example implementation, two types of scores may be utilized: hard scores and fuzzy scores, as known by those of skill in the art. Fuzzy scores, for example are dependent on multiple factors and the same score may mean different things.

In accordance with an example implementation, certain scores may be common across all types of verification scores. For example a “0” may represent a very poor match, or a total mismatch, while a “100” may represent a perfect match. According to an example implementation a “255” may indicate a null (or invalid) comparison. In some cases such a null designation may be due to missing data, either in the input data or in the reference data.

For example, a null in the address score may indicate certain types of invalid addresses or missing information, while a “100” may represent a perfect match across primary and secondary address elements. In certain example implementations of the disclosed technology, a score in the range of “1-90” may be representative of a fuzzy range of scores that mean primary elements of the address disagree in ways ranging from serious to minor. Higher scores are better, with 80 or higher generally considered a “good match,” and lower scores increasingly less similar, and with “0” representing a total miss.

According to an example implementation other scores may be dependent on the type of matching being done. For example, with regard to the phone number, a “255” may represent a blank input phone number, a blank reference phone number, or both being blank. In an example implementation, a “100” may indicate that the last 7 digits of the input and reference phone numbers are an exact match, while a “0” may represent any other condition.

With regard to the SSN, and according to an example implementation a “255” may represent a blank input SSN, a blank reference SSN, or both being blank. one side or the other is blank. In an example implementation, if neither of the SSNs (input or reference) are blank, then a computed score may be determined as 100 minus a ‘similarity score’. For example, the computed scored may result in a perfect match of “100” if ‘similarity score’ is 0, and generally speaking, a very close match may result in a computed score of 80 or 90, while a 70 may be considered a possible match.

According to an example implementation, an entity's date of birth (DOB) may be scored by comparing the input data with reference data. In one example implementation the standard format for dates may be represented by a year, month, day format (yyyymmdd). In certain example implementations of the disclosed technology, null values may be referenced or identified by scores of 00 or 01. In an example implementation, a “255” may represent invalid or missing DOB data in the input data, the reference data, or both while a “100” may represent a perfect yyyymmdd match. According to an example implementation, “80” may represent that yyyymm are the same and the day data (dd) is null in the input data, the reference data, or both. According to an example implementation, “60” may represent that yyyymm are the same, but the days are different in the input an reference data, but not null. According to an example implementation, “40” may represent that yyyy are the same, but mmdd in the input data, the reference data, or both is null. According to an example implementation “20” may represent that yyyy are the same, but the in the input data the reference data differ by month and day. Finally a “0” score may represent that there is no match between in the input DOB data and the reference DOB data.

With regard to the name, a “255” may represent a blank input name, a blank reference name, or both being blank, or no first, middle, or last name. Otherwise the score may be computed similarly to SSN. For example, a name match algorithm may be applied to the input and reference names, and the various qualities of matches may range from a perfect match (with a verify score of 100) to a poor match (with a verify score of 50) to no match (with a score of 0).

### Scoring Examples

In accordance with an example implementation, a name scoring may be utilized to determine how close the input names (first, middle and last) match to the reference name.

| Input Name | Best Name | Score |
|---|---|---|
| ‘RICHARD L TAYLOR’, | ‘RICHARD L TAYLOR’ | 100 |
| ‘RICH L TAYLOR’, | ‘RICHARD L TAYLOR’ | 90 |
| ‘RICH TAYLOR’, | ‘RICHARD L TAYLOR’ | 80 |
| ‘ROD L TAYLOR’, | ‘RICHARD L TAYLOR’ | 0, (believed to be |
| | | another person). |

In an example implementation, the SSN score may be used to determine how similar the input SSN is to the reference SSN.

| Input SSN | Reference SSN | Score |
|---|---|---|
| ‘ABCDEFGHI’, | ‘ABCDEFGHI’, | 100 |
| ‘ABCDEFGHZ’, | ‘ABCDEFGHI’, | 90 |
| ‘ABCDEFGZZ’, | ‘ABCDEFGHI’, | 80 |
| ‘ABCDEFZZZ’, | ABCDEFGHI’, | 70 |
| ‘ABCDEZZZZ’, | ‘ABCDEFGHI’, | 60 |
| ‘ABCDZZZZZ’, | ‘ABCDEFGHI’, | 40 |
| ‘ZZZZZFGHI’, | ‘ABCDEFGHI’, | 40 |

Certain embodiments of the disclosed technology may enable the detection of possible, probable, and/or actual fraud associated with a request for a payment or a benefit to a governmental agency. Embodiments disclosed herein may provide systems and methods for detecting identity misrepresentation, identity creation or identity usurpation related to the request. According to an example implementation of the disclosed technology, information supplied by a requester, together with information obtained from other sources, such as public or private databases, may be utilized to determine if the request is likely to be fraudulent or legitimate.

Certain embodiments of the disclosed technology may enable detection of various requests for payment, benefit, service, refund, etc. from a government agency or entity. The government agency, as referred to herein, may include any government entity or jurisdiction, including but not limited to federal, state, district, county, city, etc. Embodiments of the disclosed technology may be utilized to detect fraud associated with non-government entities. For example, embodiments of the disclosed technology may be utilized by various businesses, corporations, non-profits, etc., to detect fraud.

In one example application of the disclosed technology, suspect or fraudulent tax returns refund requests may be detected. For example, the disclosed technology may utilize information supplied by the refundee together with information obtained from other sources, such as public or private databases, to determine if the refund request is likely to be fraudulent or legitimate. Various exemplary embodiments of the disclosed technology will now be described with reference to the accompanying figures.

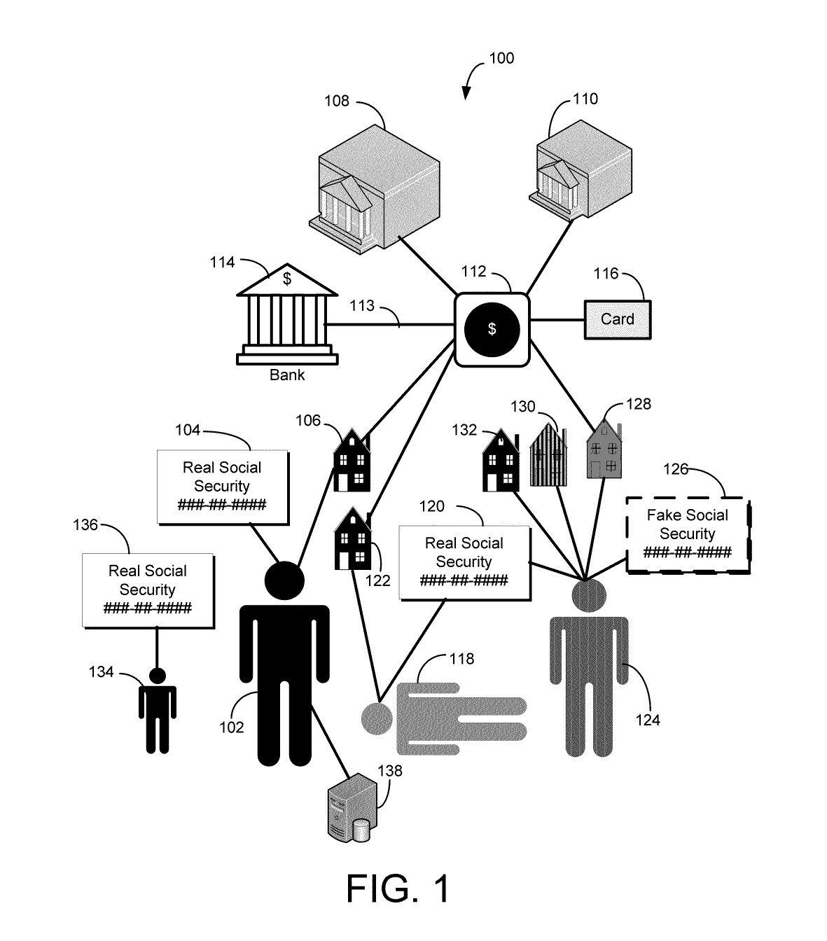

FIG. 1 shows a block diagram illustrating various scenarios associated with a request for payment or benefit, according to exemplary embodiments of the disclosed technology. In one example scenario, a legitimate requester 102 may submit request for payment or benefit to a governmental entity 108. In another example implementation, the request may be submitted to a private or public entity, such as a company 110. The request, in one example implementation, may be in the form of a tax return to the governmental entity 108, for example, the Internal Revenue Service (IRS) or a State Revenue Department.

In one example implementation, the legitimate requester 102 may have a legitimate social security number 104 associated with their name. In certain exemplary embodiments, the legitimate requester 102 may also have a legitimate address 106 associated with their name and/or social security number 104. According to certain exemplary embodiments, one or more databases 138 may be utilized, for example, to verify that the name, social security number 104, and/or address 106 match the identity of the legitimate requester 102. In a typical normal scenario, the legitimate requester 102 may submit the request for payment or benefit, and governmental entity 108 may provide the payment or benefit 112. For example, the payment or benefit, in one example implementation may be a tax refund. Accordingly, in certain example implementation, the payment or benefit 112 may be dispersed to the legitimate requester 102 by one or more of: (1) a check mailed to the legitimate address 106; (2) a debit card 116 mailed to the legitimate address 106; or (3) electronic funds transferred 113 to the legitimate taxpayer's 102 bank account 114. In other example implementations, the payment or benefit 112 may dispersed or provided according to the normal procedures of the providing entity. In such a scenario, the system 100 may work quickly and efficiently to provide payment or service (for example a refund tax overpayment) to the legitimate requester 102.

Unfortunately, there exists other scenarios, as depicted in FIG. 1, where a fraudster 124 may apply for payment or benefit 112 using misrepresented or stolen identity information. In one exemplary scenario, the fraudster 124 may apply for payment or benefit 112 using a social security number 120 and name associated with a deceased person 118. In certain scenarios, the fraudster 124 may open a bank account 114 in the name of the deceased person 118 and request the payment or benefit 112 in the form of an electronic deposit 113. In another scenario, the fraudster 124 may request the payment or benefit 112 in the form of a debit card. Each of these scenarios may result in the fraudster 124 obtaining the payment or benefit 112 without having to present positive identification, for example, as is typically needed to cash a check.

In certain scenarios, the fraudster 124 may actually reside at a first address 132, or even in jail 130, but may submit a request for payment or benefit using a second address 128 to avoid being tracked down. In certain scenarios, the fraudster 124 may provide a fabricated social security number 126 in requesting the payment or benefit. In yet another scenario, the fraudster 126 may steal the real social security number 136 associated with a child 134 to obtain payment or benefit.

Exemplary embodiments of the disclosed technology may be utilized to detect a potential fraudulent requests for payment or benefits, and may be utilized to cancel a payment or benefit to a potential fraudster 124. Other exemplary embodiments of the disclosed technology may be utilized to detect false positive situations and allow payment or benefit for scenarios that may otherwise be flagged as being suspicious. For example, a legitimate scenario that can appear as fraudulent involves taxable income from a first job. Typically, such taxpayers in this category may be minors with no public record associated with a residence or prior income. Embodiments of the disclosed technology may utilize social security number patterns, blocks, etc., and/or the age of the requester 102 124 to determine legitimacy of the request and/or the legitimacy of the requester's identity.

According to certain exemplary embodiments of the disclosed technology, a requester 102 124 may provide certain entity-supplied information with a request for payment or benefit 112 that includes at least a name, social security number, and mailing address. In an exemplary embodiment, one or more databases 138 may be queried with the entity-supplied information. For example, the one or more databases 138 may include public or private databases. In accordance with certain exemplary embodiments, one or more public records may be utilized verify entity-supplied information or retrieve additional information based on the entity-supplied information. According to exemplary embodiments, the public records may include one or more of housing records, vehicular records, marriage records, divorce records, hospital records, death records, court records, property records, incarceration records, or utility records. In exemplary embodiments, the utility records can include one or more of utility hookups, disconnects, and associated service addresses.

According to exemplary embodiments, a plurality of independent information may be received in response to the querying of the public or private database(s). In accordance with exemplary embodiments, the independent information may include, but is not limited to (1) an indication of whether or not the entity is deceased; (2) independent address information associated with the entity; (3) address validity information associated with the entity-supplied information; (3) one or more public records associated with the entity-supplied information; or (4) no information.

Exemplary embodiments of the disclosed technology may make a comparison of the entity-supplied information with the plurality of independent information to determine zero or more indicators of fraud. For example, embodiments of the disclosed technology may compare the entity-supplied information with the plurality of independent information to determine if the entity associated with the request for payment or benefit died within a timeframe that would indicate a possible non-fraud request, but with no record of association between the entity-supplied mailing address and the address information obtained via the independent information. Such a scenario may represent a situation where a fraudster 124 has obtained a name and social security information 120 from a deceased person 118, but where the address provided does not correspond with the known residence address 122 of the deceased person 118, or with any known relatives or associates of the deceased person 118. This scenario may be an indicator of a attempt by a fraudster 124 to have a deceased person's 118 payment or benefit 112 sent to a post office box or other address that can be monitored by the fraudster 124 without any direct tie to the fraudster 124. Exemplary embodiments of the disclosed technology may include a length of time entity has been deceased (if the entity is deceased) in the determination of fraud indicators. For example, a request for payment or benefit listing a person known to be dead for 10 years is very likely a fraudulent refund request.

According to another exemplary embodiment of the disclosed technology, a comparison may be made with the entity-supplied mailing address and the independent information to determine if the entity-supplied mailing address is invalid with no record of association between a zip code of the entity-supplied mailing address and one or more zip codes associated with the independent address information. For example, situations exist where a legitimate taxpayer 102 may abbreviate or include a typographical error their return mailing address, but they may provide a correct zip code that could be verified with the independent information. However, a fraudster 124 may be likely to use a completely different zip code, and in such situations, embodiments of the disclosed technology may utilize the inconsistent zip code information to flag a possible fraudulent tax return request.

According to another exemplary embodiment of the disclosed technology, a comparison may be made with the entity-supplied mailing address and the independent information to determine whether or not there is any record of association between the entity-supplied mailing address and any independent address information, such as the address of a relative, or associate. According to an exemplary embodiment, if there is no association between the entity-supplied mailing address and any independent address information, then there is a high likelihood that the payment or benefit request is fraudulent.

In accordance with certain exemplary embodiments of the disclosed technology, fraud false positive indicators may determined, based at least in part on a comparison of the entity-supplied information with the plurality of independent information. Absent of exemplary embodiments of the disclosed technology, certain situations may be incorrectly flagged as fraudulent, and may create costly and unnecessary delays related to the disbursement of the payment or benefit. In one exemplary embodiment, a fraud false positive indicator may be based on an analysis to detect if the entity-supplied mailing address is invalid, but with a record of association between a zip code of the entity-supplied mailing address and one or more zip codes associated with the independent address information. This represents a situation where a legitimate requester 102 has abbreviated their address or included a typographical error in the address, but the zip code corresponds with one known to be associated with the legitimate requester 102.

According to another exemplary embodiment, a fraud false positive indicator may be based on the entity-supplied social security number when there is no independent information available. For example, in one exemplary embodiment, the entity-supplied social security number may be checked to determine if it is valid and issued within 3 to 15 years, and the independent information can be checked to see if it includes information. If no independent information is available and if the entity-supplied social security number is valid and issued within 3 to 15 years, then this information may provide an indication that the requesting entity is a minor. In another exemplary embodiment, the social security number may be checked to determine if the entity is at least 24 years old with a valid social security number issued within 3 to 15 years, and the obtained independent information includes no information. In this scenario, exemplary embodiments of the disclosed technology may provide an indication that the requesting entity is an immigrant.

According to exemplary embodiments of the disclosed technology, one or more public or private databases 138 may be accessed to receive independent information. For example, one or more public records may be provide housing records, vehicular records, marriage records, divorce records, hospital records, death records, court records, property records, incarceration records, or utility records. In exemplary embodiments, the utility records may include one or more of utility hookups, disconnects, and associated service addresses. According to exemplary embodiments of the disclosed technology, such public records may be searched by social security number and/or name to provide independent information that can be utilized to verify entity-supplied information. For example, entity-supplied address information can be checked to determine if it corresponds to any addresses of relatives or associates of the entity.

According to certain exemplary embodiments of the disclosed technology, fraud associated with a request for payment or benefit may be detected by querying a Do Not Pay list with a combination of entity-supplied information and independent information obtained from one or more public records. For example, a person may be listed on a Do Not Pay list for a number of reasons, including being incarcerated, not paying child support, having liens, etc. Persons on the Do Not Pay list may supply an incorrect social security number or a slight misspelling of a name to avoid being matched with the information on the Do Not Pay list.

An example implementation of the disclosed technology may include receiving entity-supplied information that includes at least a name and a social security number and querying one or more public records with the entity-supplied information. Certain exemplary embodiments of the disclosed technology may receive, based at least on the querying, public data that includes one or more of a second social security number or variant of a social security number associated with entity-supplied name, a second name associated with the entity-supplied social security number, or a name variant associated with the entity-supplied social security number. For example, a variant may include information such as a name, a number, or an address, etc. that approximately matches real or legitimate information. A social security number variant, for example, may be nearly identical to a legitimate social security number, but with one or more numbers changed, transposed, etc.

According to exemplary embodiments of the disclosed technology, a Do Not Pay list may be queried with one or more combinations and/or variants of the entity-supplied information and the received public data, and a fraud alert may be output if the one or more combinations and/or variants result in a match with at least one record in the Do Not Pay list. Thus, in certain example implementations, the entity-supplied information may be compared with variations of information on the Do Not Pay list (and/or other public or private information) to determine a possible match. Conversely, in other example implementations, information obtained from the Do Not Pay list (and/or other public or private sources) may be compared with variations of the entity-supplied information to determine possible matches.

According to certain exemplary embodiments, the Do Not Pay list may be queried with one or more combinations of the entity-supplied name and entity-supplied social security number, the entity-supplied name and a second social security number or a variant of the social security number, the second name or name variant and the entity supplied social security number, or the second name or name variant and the second social security number or variant of the social security number. According to exemplary embodiments, if one of the combinations or variants matches the information on the Do Not Pay list, then a fraud alert may be output.

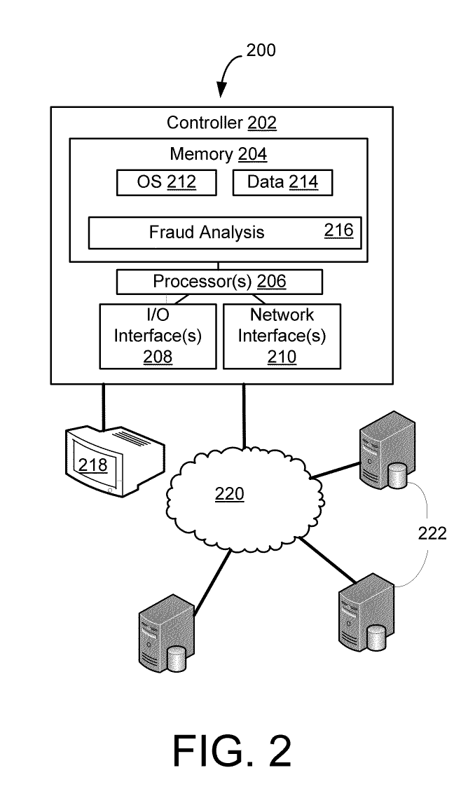

FIG. 2 depicts a block diagram of an illustrative fraud detection system 200 according to an exemplary embodiment of the disclosed technology. The system 200 includes a controller 202 that includes a memory 204, one or more processors 206, an input/out interface 208 for communicating with a local monitor 218 and input devices, and one or more network interfaces 210 for communicating with local or remote servers or databases 222, which may be accessed through a local area network or the internet 220. According to exemplary embodiments, the memory may included an operating system 212, data 214, and one or more fraud analysis modules 216.

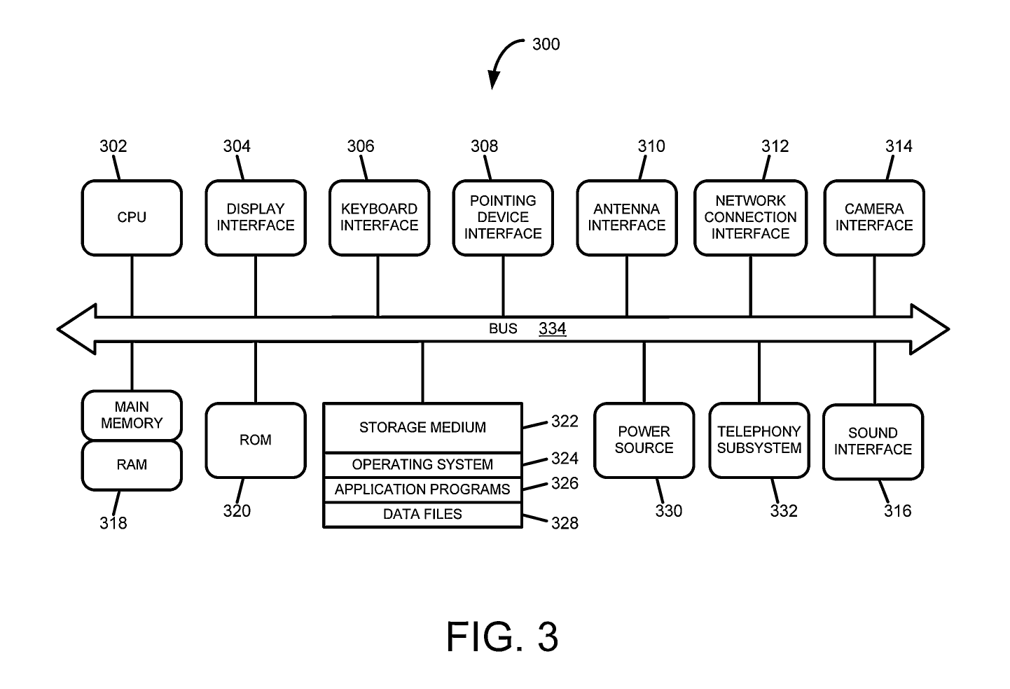

Various embodiments of the communication systems and methods herein may be embodied in non-transitory computer readable media for execution by a processor. An exemplary embodiment may be used in an application of a mobile computing device, such as a smartphone or tablet, but other computing devices may also be used. FIG. 3 illustrates schematic diagram of internal architecture of an exemplary mobile computing device 300. It will be understood that the architecture illustrated in FIG. 3 is provided for exemplary purposes only and does not limit the scope of the various embodiments of the communication systems and methods.

FIG. 3 depicts a block diagram of an illustrative computer system architecture 300 according to an exemplary embodiment of the disclosed technology. Certain aspects of FIG. 3 may also be embodied in the controller 202, as shown in FIG. 2. Various embodiments of the communication systems and methods herein may be embodied in non-transitory computer readable media for execution by a processor. It will be understood that the architecture illustrated in FIG. 3 is provided for exemplary purposes only and does not limit the scope of the various embodiments of the communication systems and methods.

The architecture 300 of FIG. 3 includes a central processing unit (CPU) 302, where computer instructions are processed; a display interface 304 that acts as a communication interface and provides functions for rendering video, graphics, images, and texts on the display; a keyboard interface 306 that provides a communication interface to a keyboard; and a pointing device interface 308 that provides a communication interface to a pointing device or touch screen. Exemplary embodiments of the architecture 300 may include an antenna interface 310 that provides a communication interface to an antenna; a network connection interface 312 that provides a communication interface to a network. In certain embodiments, a camera interface 314 is provided that acts as a communication interface and provides functions for capturing digital images from a camera. In certain embodiments, a sound interface 316 is provided as a communication interface for converting sound into electrical signals using a microphone and for converting electrical signals into sound using a speaker. According to exemplary embodiments, a random access memory (RAM) 318 is provided, where computer instructions and data are stored in a volatile memory device for processing by the CPU 302.

According to an exemplary embodiment, the architecture 300 includes a read-only memory (ROM) 320 where invariant low-level systems code or data for basic system functions such as basic input and output (I/O), startup, or reception of keystrokes from a keyboard are stored in a non-volatile memory device. According to an exemplary embodiment, the architecture 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an exemplary embodiment, the architecture 300 includes a power source 330 that provides an appropriate alternating current (AC) or direct current (DC) to power components. According to an exemplary embodiment, the architecture 300 includes and a telephony subsystem 332 that allows the device 300 to transmit and receive sound over a telephone network. The constituent devices and the CPU 302 communicate with each other over a bus 334.

In accordance with exemplary embodiments, the CPU 302 has appropriate structure to be a computer processor. In one arrangement, the computer CPU 302 is more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data is stored in the RAM 318, where the data is accessed by the computer CPU 302 during execution. In one exemplary configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

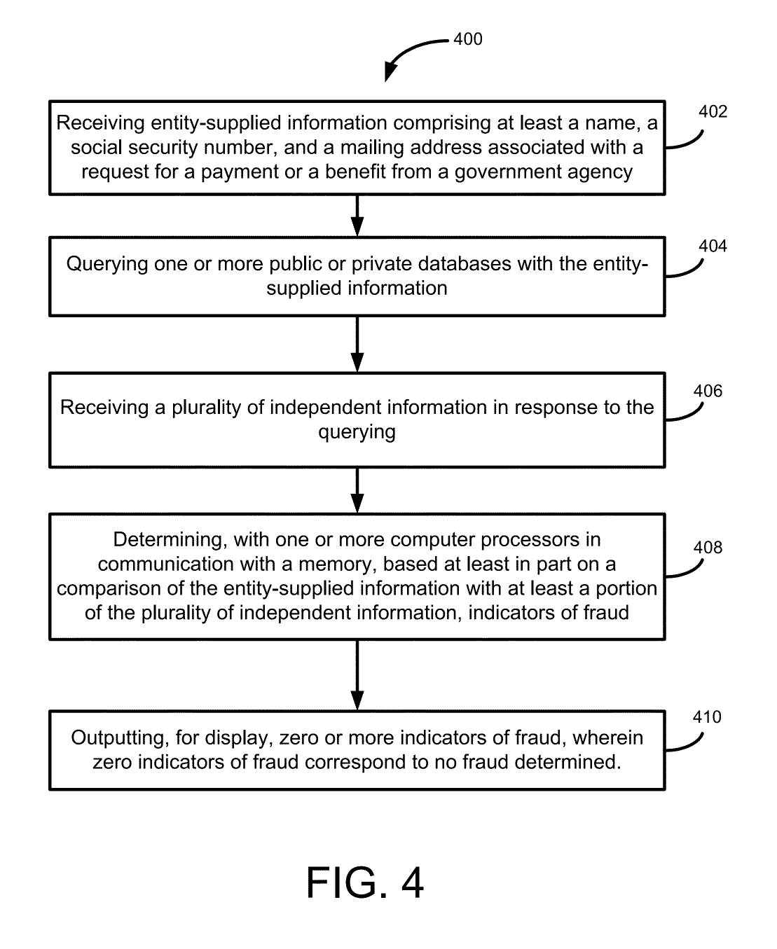

An exemplary method 400 will now be described with reference to the flowchart of FIG. 4 The method may be utilized for detecting fraud related to an identity misrepresentation, identity creation or identity usurpation. The method 400 starts in block 402, and according to an exemplary embodiment of the disclosed technology includes receiving entity-supplied information comprising at least a name, a social security number, and a mailing address associated with a request for a payment or a benefit from a government agency. In block 404, the method 400 querying one or more public or private databases with the entity-supplied information. In block 406, the method 400 includes receiving a plurality of independent information in response to the querying.

According to certain example embodiments, the plurality of independent information can include one or more of (1) an indication of whether or not the entity is deceased, and a date of death when the entity is indicated as deceased; (2) independent address information associated with the entity; (3) address validity information associated with the entity-supplied information; (4) one or more records associated with the entity-supplied information; or (5) no information.

In block 408, the method 400 includes determining, with one or more computer processors in communication with a memory, based at least in part on a comparison of the entity-supplied information with at least a portion of the plurality of independent information, one or more indicators of fraud. For example, the indicators of fraud may include one or more of (1) the entity is indicated as deceased within a year of the request or died within a timeframe of the year that would indicate a possible non-fraud request for the payment or the benefit; (2) the entity-supplied mailing address does not match with any of the independent address information; (3) the entity-supplied mailing address having no record of association with any independent address information, including addresses of relatives or addresses of associates; and (4) the entity-supplied mailing address includes an entity-supplied zip code having no record of association with one or more zip codes associated with the independent address information.

In block 410, the method 400 includes outputting, for display, zero or more indicators of fraud, wherein zero indicators of fraud correspond to no fraud determined.

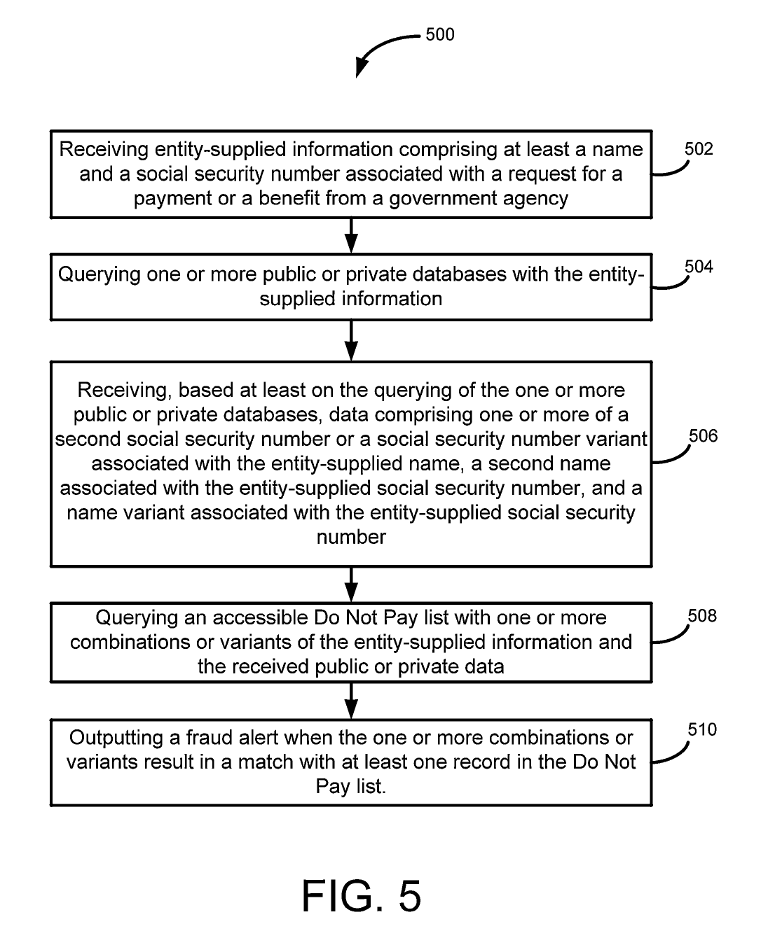

Another exemplary method 500 for detecting fraud related to an identity misrepresentation, identity creation or identity usurpation will now be described with reference to the flowchart of FIG. 5. The method 500 starts in block 502, and according to an exemplary embodiment of the disclosed technology includes receiving entity-supplied information comprising at least a name and a social security number associated with a request for a payment or a benefit from a government agency. In block 504, the method 500 includes querying one or more public or private databases with the entity-supplied information. In block 506, the method 500 includes receiving, based at least on the querying of the one or more public or private databases, data comprising one or more of a second social security number or a social security number variant associated with the entity-supplied name, a second name associated with the entity-supplied social security number, and a name variant associated with the entity-supplied social security number. In block 508, the method 500 includes querying an accessible Do Not Pay list with one or more combinations or variants of the entity-supplied information and the received public or private data. In block 510, the method 500 includes outputting a fraud alert when the one or more combinations or variants result in a match with at least one record in the Do Not Pay list.

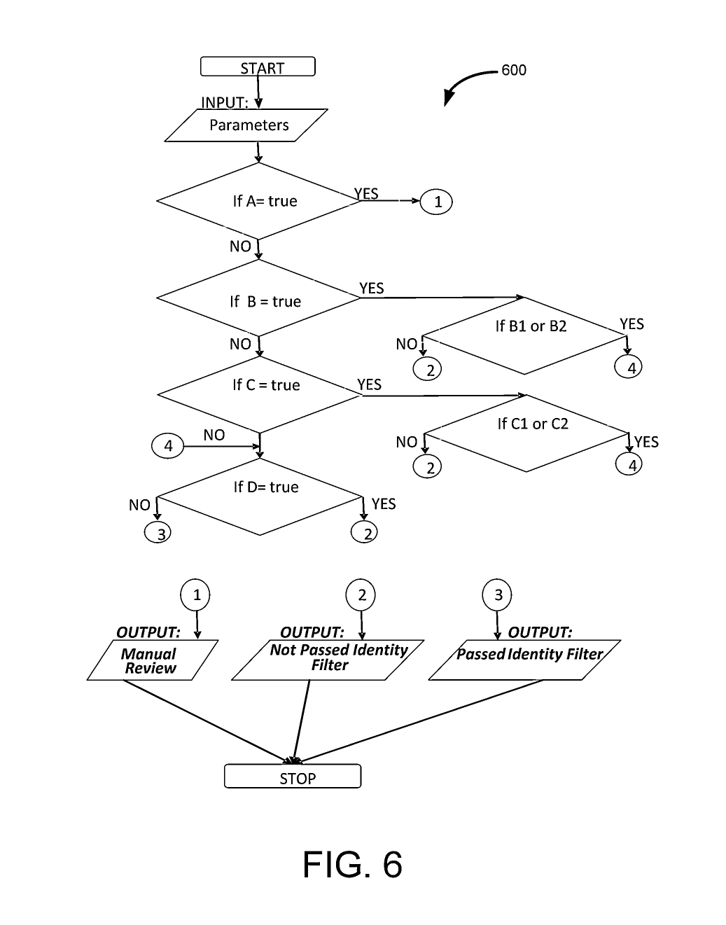

FIG. 6 depicts a flow diagram 600, according to an example process implementation. The flow diagram 600 may be utilized to test the input data, for example, so that a determination may be made, with a computer processor, as to whether or not the identity associated with and represented by the input data passes certain tests. For example, as shown in FIG. 6, input parameters and/or attributes associated with the input data may be tested based on a number of variables, scored, and sorted in to records that pass the identity filter tests, records that do not pass the identity filter tests, and records that may require manual review.

### Attribute Examples

Table 1 lists some of the attributes, descriptions, and example relative order of importance with respect to determining indicators of fraud, according to an example implementation of the disclosed technology. In accordance with certain example implementations, such attributes may be utilized for the various tests in conjunction with the flow diagram 600 as shown in FIG. 6. For example, the attribute VariationSearchAddrCount may be tested to see if it is associated with >2 addresses, and if so (and perhaps depending on other such tests with other attributes), the record may be flagged as not passing the identity filter test, and thus, may be an indicator of fraud.

TABLE 1

| Example | | |
|---|---|---|
| Order of | | |
| Importance | Attribute | Attribute Description |
| 1 | CorrelationSSNAddrCount | Total number of sources reporting input |
| | | SSN with input address |
| 2 | AssocDistanceClosest | Distance in miles between identity and |
| | | closest first-degree relative or associate |
| 3 | SearchUnverifiedAddrCountYear | Number of searches in the last year for |
| | | the identity using an address that was not |
| | | on the identity's file at the time of the |
| | | search |
| 4 | VariationSearchAddrCount | Total number of addresses associated |
| | | with the identity in searches |
| 5 | AddrChangeDistance | Distance in miles between input address |
| | | and the most recent unique address |
| 6 | IDVerRiskLevel | Indicates the fraud-risk level based on |
| | | how well the input components match |
| | | the information found for the input |
| | | identity |
| 6a | IDVerSSN | Indicates if the SSN is verified |
| 6b | IDVerName | Indicates if the identity's name is verified |
| 6c | IDVerAddress | Indicates if the input address is verified |
| 6d | IDVerPhone | Indicates if the input phone is verified |
| 7 | DivAddrSSNCount | Total number of unique SSNs currently |
| | | associated with input address |
| 8 | BankruptcyAge | Time since most recent bankruptcy filing |
| 9 | CorrelationSSNNameCount | Total number of sources reporting input |
| | | SSN with input name |
| 10 | PBProfile | Profile of purchase activity |
| 11 | VariationSearchSSNCount | Total number of SSNs associated with |
| | | the identity in searches |
| 12 | ValidationSSNProblems | Indicates SSN validation status - |
| | | Deceased |
| 13 | CriminalCount | Total criminal convictions |
| 14 | InputAddrNBRHDMultiFamilyCount | Total number of multi-family properties |
| | | in neighborhood |
| 14a | InputAddrNBRHDSingleFamilyCount | Total number of single family properties |
| | | in neighborhood |
| 14b | InputAddrNBRHDBusinessCount | Total number of businesses in |
| | | neighborhood |
| 15 | CurrAddrMedianIncome | Current address neighborhood median |
| | | income based on U.S. Census data |
| 16 | ValidationAddrProblems | Indicates input address validation status - |
| | | Invalid |
| 17 | SourceProperty | Indicates if identity is associated with the |
| | | ownership of real property |
| 18 | InputAddrDelivery | Indicates the delivery sequence status of |
| | | the input address - Vacant |
| 19 | SearchUnverifiedDOBCountYear | Number of searches in the last year for |
| | | the identity using a date of birth that was |
| | | not in the identity's record at the time of |
| | | search |
| 20 | ArrestAge | Time since most recent arrest |
| 21 | SourceEducation | Indicates if identity attended or is |
| | | attending college |
| 22 | InputAddrDwellType | Indicates input address dwelling type |
| 23 | AssocHighRiskTopologyCount | Total count of first-degree relatives or |
| | | associates that are reported from high |
| | | risk sources |
| 24 | SourceAssets | Indicates if identity is associated with the |
| | | ownership of assets (vehicles, watercraft, |
| | | and aircraft) |
| 25 | ValidationSSNProblems | Indicates SSN validation status - Invalid |
| 26 | SourcePhoneDirectoryAssistance | Indicates if identity has a phone listing in |
| | | Electronic Directory Assistance (EDA) |

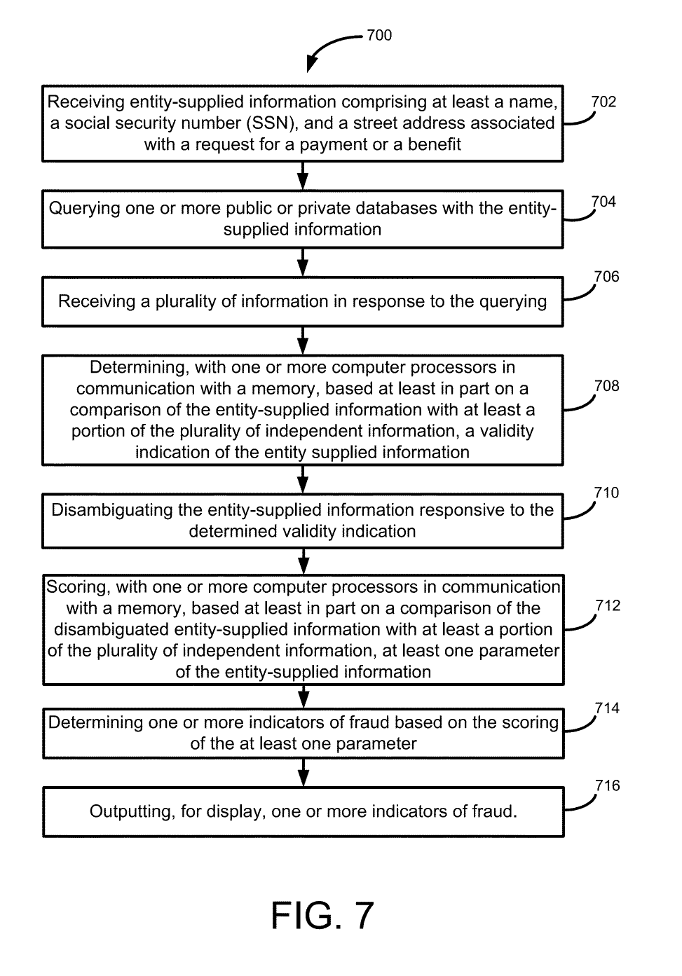

An exemplary method 700 that may be utilized, for example, to disambiguating input information and to determine a likelihood of fraud, will now be described with reference to the flowchart of FIG. 7. The method 700 starts in block 702, and according to an exemplary embodiment of the disclosed technology includes receiving entity-supplied information comprising at least a name, a social security number (SSN), and a street address associated with a request for a payment or a benefit. In block 704, the method 700 includes querying one or more public or private databases with the entity-supplied information. In block 706, the method 700 includes receiving a plurality of information in response to the querying. In block 708, the method 700 includes determining, with one or more computer processors in communication with a memory, based at least in part on a comparison of the entity-supplied information with at least a portion of the plurality of independent information, a validity indication of the entity supplied information. In block 710, the method 700 includes disambiguating the entity-supplied information responsive to the determined validity indication. In block 712, the method 700 includes scoring, with one or more computer processors in communication with a memory, based at least in part on a comparison of the disambiguated entity-supplied information with at least a portion of the plurality of independent information, one or more parameters associated with the entity-supplied information. In block 714, the method 700 includes determining one or more indicators of fraud based on the scoring of the at least one parameter. In block 716, the method 700 includes outputting, for display, one or more indicators of fraud.

According to an example implementation, the one or more parameters associated with the entity-supplied information may include a distance between the entity-supplied street address and a street address of one or more entity relatives or entity associates. According to an example implementation, the one or more parameters associated with the entity-supplied information may include a number of records associating the entity-supplied SSN and the entity-supplied street address. According to an example implementation, the one or more parameters associated with the entity-supplied information may include a number of unique SSNs associated with the entity-supplied street address. According to an example implementation, the one or more parameters associated with the entity-supplied information may include a number sources reporting the entity-supplied SSN with the entity-supplied name. According to an example implementation, the one or more parameters associated with the entity-supplied information may include a number of other entities associated with the entity-supplied SSN.

Certain example implementations further include scoring neighborhood fraud metrics based on the entity-supplied street address based on one or more of: presence of businesses in the surrounding neighborhood, density of housing in the neighborhood; and median income in the neighborhood.

In an example implementation, determining the validity indication of the entity supplied information further includes determining one or more of: whether entity is deceased; whether the entity is currently incarcerated; whether the entity has an incarceration record; time since incarceration if the entity has an incarceration record; whether the entity has been involved in a bankruptcy, and whether the entity-supplied address is included in public record.

According to an example implementation, the plurality of independent information includes, as applicable: an indication of whether or not the entity is deceased, and a date of death when the entity is indicated as deceased; independent address information associated with the entity; address validity information associated with the entity-supplied information; one or more records associated with the entity-supplied information; or no information.

In certain example implementations of the disclosed technology, receiving the plurality of independent information includes receiving the one or more records comprising one or more of housing records, vehicular records, marriage records, divorce records, hospital records, death records, court records, property records, incarceration records, tax records, and utility records, wherein the utility records comprise one or more of utility hookups, disconnects, and associated service addresses.

In certain example implementations of the disclosed technology, receiving the independent address information or the address validity information includes receiving one or more addresses of relatives or associates of the entity.

In an example implementation, the one or more public or private databases are independent of the government agency.

In an example implementation, receiving the entity-supplied information includes receiving the name, social security number (SSN), and street address associated with a request for a payment or a benefit from a government agency.

According to exemplary embodiments, certain technical effects are provided, such as creating certain systems and methods that detect fraud related to a request for payment or benefit. Exemplary embodiments of the disclosed technology can provide the further technical effects of providing systems and methods for determining and eliminating false positives with respect to fraud. Certain example embodiments include technical effects of providing systems and methods for disambiguating input information, resulting in higher quality determinations of fraudulent activities.

In exemplary embodiments of the disclosed technology, the fraud detection system 200 and/or the fraud detection system architecture 300 may include any number of hardware and/or software applications that are executed to facilitate any of the operations. In exemplary embodiments, one or more I/O interfaces may facilitate communication between the fraud detection system 200 and/or the fraud detection system architecture 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the fraud detection system 200 and/or the fraud detection system architecture 300. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the fraud detection system 200 and/or the fraud detection system architecture 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ enabled network, a Wi-Fi™ enabled network, a satellite-based network any wired network, any wireless network, etc., for communication with external devices and/or systems.

As desired, embodiments of the disclosed technology may include the fraud detection system 200 and/or the fraud detection system architecture 300 with more or less of the components illustrated in FIG. 2 and FIG. 3.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
receiving entity-supplied information comprising at least a name, a social security number (SSN), and a street address associated with a request for a payment or a benefit;
querying one or more public or private databases with the entity-supplied information;
receiving a plurality of information in response to the querying;
determining, with one or more computer processors in communication with a memory, based at least in part on a comparison of the entity-supplied information with at least a portion of the plurality of independent information, a validity indication of the entity supplied information;
disambiguating the entity-supplied information responsive to the determined validity indication;
scoring, with one or more computer processors in communication with a memory, based at least in part on a comparison of the disambiguated entity-supplied information with at least a portion of the plurality of independent information, at least one parameter of the entity-supplied information;
determining one or more indicators of fraud based on the scoring of the at least one parameter; and
outputting, for display, one or more indicators of fraud.

2. The method of claim 1, wherein the at least one parameter of the entity-supplied information comprises a distance between the entity-supplied street address and a street address of one or more entity relatives or entity associates.

3. The method of claim 1, wherein the at least one parameter of the entity-supplied information comprises a number of records associating the entity-supplied SSN and the entity-supplied street address.

4. The method of claim 1, wherein the at least one parameter of the entity-supplied information comprises a number of unique SSNs associated with the entity-supplied street address.

5. The method of claim 1, wherein the at least one parameter of the entity-supplied information comprises a number sources reporting the entity-supplied SSN with the entity-supplied name.

6. The method of claim 1, wherein the at least one parameter of the entity-supplied information comprises a number of other entities associated with the entity-supplied SSN.

7. The method of claim 1, further comprising scoring neighborhood fraud metrics based on the entity-supplied street address and further based on one or more of: presence of businesses in the surrounding neighborhood; density of housing in the neighborhood; and median income in the neighborhood.

8. The method of claim 1, wherein determining the validity indication of the entity supplied information further comprises determining one or more of: whether entity is deceased; whether the entity is currently incarcerated; whether the entity has an incarceration record; time since incarceration if the entity has an incarceration record; whether the entity has been involved in a bankruptcy, and whether the entity-supplied address is included in public record.

9. The method of claim 1, wherein the plurality of independent information includes one or more of: an indication of whether or not the entity is deceased; a date of death when the entity is indicated as deceased; independent address information associated with the entity; address validity information associated with the entity-supplied information; and one or more records associated with the entity-supplied information; or no information.

10. The method of claim 1, wherein receiving the plurality of independent information comprises receiving the one or more records comprising one or more of housing records, vehicular records, marriage records, divorce records, hospital records, death records, court records, property records, incarceration records, tax records, and utility records, wherein the utility records comprise one or more of utility hookups, disconnects, and associated service addresses.

11. The method of claim 1, wherein receiving the independent address information or the address validity information comprises receiving one or more addresses of relatives or associates of the entity.

12. The method of claim 1, wherein the one or more public or private databases are independent of a government agency.

13. The method of claim 1, wherein receiving the entity-supplied information comprising receiving the name, SSN, and street address is associated with a request for a payment or a benefit from a government agency.

14. A system comprising:
at least one memory for storing data and computer-executable instructions; and
at least one processor configured to access the at least one memory and further configured to execute the computer-executable instructions to:
receive entity-supplied information comprising at least a name, a social security number (SSN), and a street address associated with a request for a payment or a benefit;
query one or more public or private databases with the entity-supplied information;
receive a plurality of information in response to the querying;
determine, with the at least one processor, and based at least in part on a comparison of the entity-supplied information with at least a portion of the plurality of independent information, a validity indication of the entity supplied information;
disambiguate, with the at least one processor, the entity-supplied information responsive to the determined validity indication;
score, with the at least one processor, based at least in part on a comparison of the disambiguated entity-supplied information with at least a portion of the plurality of independent information, at least one parameter of the entity-supplied information;
determine one or more indicators of fraud based on the scoring of the at least one parameter; and
output, for display, at least one of the one or more indicators of fraud.

15. The system of claim 14, wherein the at least one parameter of the entity-supplied information comprises one or more of:
a distance between the entity-supplied street address and a street address of one or more entity relatives or entity associates;
a number of records associating the entity-supplied SSN and the entity-supplied street address;
a number of unique SSNs associated with the entity-supplied street address;
a number sources reporting the entity-supplied SSN with the entity-supplied name; and
a number of other entities associated with the entity-supplied SSN.

16. The system of claim 14, wherein the at least one processor is further configured to score neighborhood fraud metrics based on the entity-supplied street address and further based on one or more of: presence of businesses in the surrounding neighborhood; density of housing in the neighborhood; and median income in the neighborhood.

17. The system of claim 14, wherein validity indication of the entity supplied information is further determined based one or more of: whether entity is deceased; whether the entity is currently incarcerated; whether the entity has an incarceration record; time since incarceration if the entity has an incarceration record; whether the entity has been involved in a bankruptcy, and whether the entity-supplied address is included in public record.

18. The system of claim 14, wherein the plurality of independent information includes one or more of: an indication of whether or not the entity is deceased; a date of death when the entity is indicated as deceased; independent address information associated with the entity; address validity information associated with the entity-supplied information; one or more records associated with the entity-supplied information, housing records, vehicular records, marriage records, divorce records, hospital records, death records, court records, property records, incarceration records, tax records, and utility records, wherein the utility records comprise one or more of utility hookups, disconnects, and associated service addresses.

19. The system of claim 14, wherein receiving the independent address information or the address validity information comprises receiving one or more addresses of relatives or associates of the entity.

20. One or more computer readable media comprising computer-executable instructions that, when executed by one or more processors, configure the one or more processors to perform the method of:
receiving entity-supplied information comprising at least a name, a social security number (SSN), and a street address associated with a request for a payment or a benefit;
querying one or more public or private databases with the entity-supplied information;
receiving a plurality of information in response to the querying;
determining, with one or more computer processors in communication with a memory, based at least in part on a comparison of the entity-supplied information with at least a portion of the plurality of independent information, a validity indication of the entity supplied information;
disambiguating the entity-supplied information responsive to the determined validity indication;
scoring, with one or more computer processors in communication with a memory, based at least in part on a comparison of the disambiguated entity-supplied information with at least a portion of the plurality of independent information, at least one parameter of the entity-supplied information;
determining one or more indicators of fraud based on the scoring of the at least one parameter; and
outputting, for display, one or more indicators of fraud.
